(19) United States
(12) Patent Application Publication
(10) Pub. No.: US 2005/0036331 A1
(43) Pub. Date: Feb. 17, 2005

(54) Modular headlight structure for vehicle and a method for manufacturing the same

(76) Inventors: Jean Phillipe Crepeau, Bromont (CA); Alexandre Curthelet, Granby (CA); Louis Morasse, Bromont (CA)

Correspondence Address: PILLSBURY WINTHROP, LLP, P.O. BOX 10500, MCLEAN, VA, 22102, US

(21) Appl. No.: 10/637,655

(22) Filed: Aug. 11, 2003

Related U.S. Application Data
(60) Provisional application No. 60/402,089, filed on Aug. 9, 2002.

(51) Int. Cl. F21V 7/00

(52) U.S. Cl. 362/516

(57) ABSTRACT

A headlight assembly for a vehicle is disclosed. The headlight assembly includes a mounting plate, a reflector coupled to the mounting plate via at least one joint, and at least one adjusting screw for adjusting the reflector about the at least one joint relative to the mounting plate. The headlight assembly is configured to be coupled to at least one lens selected from a group of lenses having different configurations. The headlight assembly may include a connecting member that may be configured to accept an auxiliary light source. The connecting member may be configured to accept a plurality of headlight assemblies to provide the vehicle with additional lighting.

### CROSS-REFERENCE TO RELATED APPLICATIONS

This application claims the benefit of priority to U.S. Provisional Application No. 60/402,089, titled “MODULAR HEADLIGHT STRUCTURE FOR VEHICLE AND METHOD FOR MANUFACTURING THE SAME,” filed Aug. 9, 2002, which is incorporated by reference herein in its entirety.

### FIELD OF THE INVENTION

The present invention relates to a modular headlight assembly. More specifically, the present invention relates to a modular headlight assembly for recreational vehicles, including, for example, all terrain vehicles (ATVs), boats, and snowmobiles.

### SUMMARY OF RELATED ART

Headlight assemblies for automobiles and recreational vehicles are known in the art. Conventionally, headlight assemblies are of one piece and a light bulb is removably inserted in to a rear portion of the headlight assembly. Mounted within each headlight assembly is a reflector for reflecting light from the light bulb. The reflector's function is to direct the light in a desired direction depending on the specific application. Since the reflector is rigidly mounted to the headlight assembly, adjustment of the direction of light is performed by adjusting the position of the entire headlight assembly (including the lens), relative to the body of the automobile or recreational vehicle.

As shown with reference to FIG. 12 and FIGS. 13A-13C, the headlight assembly 150 includes a lens 300 that is mounted to a body 200 of a recreational vehicle. The headlight assembly 150, including the lens 300, is integrated into the body 200. Therefore, to adjust the headlight assembly 150, the lens 300 and headlight assembly 150 must be moved together. Accordingly, a tolerance (or gap) is required between the body of the vehicle and the headlight.

Alternatively, as shown in FIG. 13C, the lens 300 is mounted behind the body 200 and a support 250 is provided. The support 250 allows the headlight assembly and lens 200 to be adjusted, however, a gap 275 must still be provided between the body 200 of the vehicle and the lens 300.

This type of adjustment requires that a tolerance be built into the body of the automobile or recreational vehicle to accommodate the adjustment of the headlight assembly. As would be easily understood by a person skilled in the art, there are numerous reasons why this assembly is not desirable, including increased drag and the appearance of such a gap on the automobile or recreational vehicle. Moreover, because a new headlight assembly must be designed for each new body design, there is a considerable cost associated with reliance on prior art headlight assemblies.

As a result of the deficiencies noted above, headlight assemblies have been redesigned so the reflector is not rigidly attached to the headlight assembly. In this configuration, a reflector specifically designed for a particular headlight assembly may be adjusted within the headlight assembly without moving or adjusting the entire headlight assembly (lens). Although the cost of such a device is greater than the headlight assembly with a fixed reflector, the appearance of the automobile or recreational vehicle is improved because the gap between the body and headlight assembly can be eliminated by having the lens directly mounted and sealed onto the body.

FIG. 14 is an illustration of such a headlight assembly 141 for an automobile. In this assembly 141, the reflectors 140 and 142 associated with the headlight assembly 141 may be adjusted without adjusting the entire assembly 141. However, the reflectors 140 and 142 and lens are specifically designed for the particular headlight assembly and vehicle body and are not transferable between different vehicles. For example, the reflector 140 on the left is different than the reflector 142 on the right and the lens is designed to fit a specific body style.

Although an adjustable reflector within a headlight assembly is more desirable, it is more expensive. Moreover, any redesign of the automobile or recreational vehicle into which such a headlight assembly is incorporated requires that the reflector and lens be redesigned as well. Therefore, a need exists to take advantage of a fixed headlight assembly where the costs of production and redesign of the headlight assembly are reduced.

### SUMMARY OF THE INVENTION

One aspect of the present invention is to overcome the problems of the prior art headlight assemblies by providing a headlight assembly that may be used with a variety of different vehicles having different lens and body configurations.

Another aspect of the present invention is to provide an adjustable and/or modular headlight assembly for use with recreational vehicles including all terrain vehicles, boats, snowmobiles, and motorcycles, for example.

According to one preferred embodiment of the present invention, there is provided a novel headlight assembly for a vehicle that includes a mounting plate and a reflector coupled to the mounting plate via at least one joint. The headlight assembly also includes at least one adjusting screw for adjusting the reflector about the at least one joint relative to the mounting plate. Further, the headlight assembly is configured to be coupled to at least one lens selected from a group of lenses having different configurations.

Additionally, the headlight assembly may include a connecting member configured to accept an auxiliary light source. The connecting member may be configured to accept a plurality of headlight assemblies to provide the vehicle with additional lighting.

These and other aspects of the present invention will become apparent when taken in conjunction with the following detailed description and drawings.

### BRIEF DESCRIPTION OF THE DRAWINGS

Preferred embodiments of the invention will be described in conjunction with the following drawings, wherein:

FIG. 1 is a detailed illustration of a headlight assembly in accordance with one embodiment of the present invention;

FIG. 2 is a perspective view of the headlight assembly detailed in FIG. 1;

FIG. 3 is a detailed illustration of a headlight assembly and lens assembly in accordance with another embodiment of the present invention;

FIG. 4 is a perspective view of the assemblies shown in FIG. 3;

FIG. 5 is a detailed illustration of a headlight assembly and a lens assembly in accordance with still another embodiment of the present invention;

FIG. 6 is a perspective view of the headlight and lens assemblies illustrated in FIG. 5;

FIG. 7 is a detailed illustration of a headlight assembly and a lens assembly in accordance with one further embodiment of the present invention;

FIG. 8 is a perspective view of the headlight and lens assemblies depicted in FIG. 7;

FIG. 9 is a detailed illustration of a headlight assembly in accordance with a additional embodiment of the present invention;

FIG. 10 is a detailed illustration of a headlight assembly and a lens assembly in accordance with another embodiment of the present invention;

FIG. 11 is a perspective view of the headlight and lens assemblies shown in FIG. 10;

FIG. 12 is a detailed illustration of a prior art headlight assembly mounted in a recreational vehicle, as viewed from the interior of the body of the vehicle;

FIGS. 13A-13C are detailed illustrations of a prior art headlight assembly mounted in a recreational vehicle; and

FIG. 14 is an illustration of a prior art headlight assembly for an automobile.

### DETAILED DESCRIPTION OF THE INVENTION

Preferred embodiments of the present invention will now be described with reference to the above figures where like reference numerals indicate like features in the various embodiments.

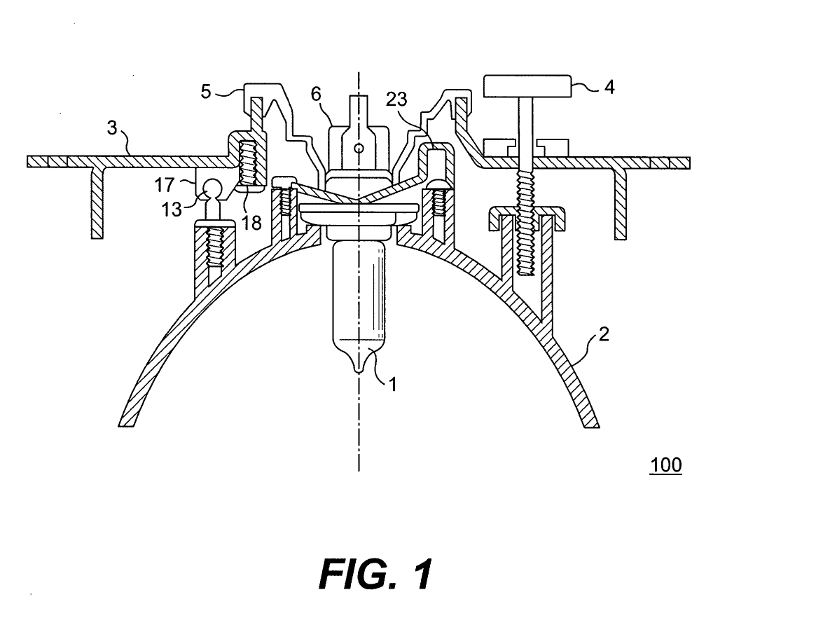

FIG. 1 is an illustration of a headlight assembly 100 in accordance with an embodiment of the present invention. The headlight assembly 100 includes a mounting plate 3, a reflector 2, and at least one adjusting screw 4. The reflector 2 is coupled to the mounting plate 3 via at least one joint 13. The reflector 2 may be designed for use in various embodiments, including but not limited to a high beam, a low beam, a center mounted headlight assembly, a left headlight assembly, and a right headlight assembly.

The headlight assembly further includes a light bulb 1 and a socket 6 configured to receive the light bulb 1. The light bulb 1 is configured to be removably inserted into the reflector 2 via a circlip 23. The headlight assembly 100 may also include a sealing element 5 for sealing the headlight assembly 100 from debris, moisture and the like. Although shown coupled to the mounting plate 3, the sealing element 5 may be coupled by conventional methods to various portions of the headlight assembly 100.

The adjusting screw 4 is provided such that a first end of the adjusting screw 4 is coupled to the reflector 2 and a second end of the adjusting screw 4 may be manipulated by a user to adjust the position of the reflector 2. The reflector 2 will pivot to adjust the direction of light emitted from the light bulb 1 when the adjusting screw 4 is manipulated. The pivoting of the reflector 2 is aided by the joint 13, which is rigidly coupled to the reflector 2 and rotatably coupled to the mounting plate 3. The joint 13 may be a ball joint or may be of any configuration known in the art which allows relative movement of one part with respect to the other. This configuration allows the reflector 2 to pivot independently relative to the entire headlight assembly 100.

Although only a single ball joint 13 and a single adjusting screw 4 are shown, it is understood that a plurality of the joints 13 and the adjusting screws 4 may be provided in various combinations. For example, a single joint 13 and two adjusting screws 4 may provide the reflector 2 with two degrees of freedom for the adjustment, such that the reflector 2 may be adjusted horizontally as well as vertically. The joint 13 may be an elongated cylindrical bearing when one adjusting screw is used.

As illustrated in FIG. 1, various portions of the headlight assembly 100 are coupled together by various means. For example, as shown in FIG. 1, the joint 13 is located in a receiving member 17, which is preferably made from a resilient plastic material such that the ball joint 13 snugly fits within the receiving member 17. The receiving member 17 may be coupled to the mounting plate 3 by a fastener 18. It should be appreciated that any conventional coupling method may be implemented to achieve similar results. For example, the receiving member 17 may be glued to the mounting plate 3. In such an embodiment, the fastener 18 may not be necessary. Additionally, the light bulb 1 may be coupled to the reflector 2 with any conventional configurations, such as with the circlip 23, as shown.

A headlight subassembly may also be defined as various combinations of elements from the headlight assembly. For example, the headlight sub-assembly may include the mounting plate 3, the reflector 2 and the adjusting screw 4. Alternatively, the headlight subassembly, may include just the mounting plate 3 and the reflector 2 or may include the reflector 2, the mounting plate 3, and the light bulb 1.

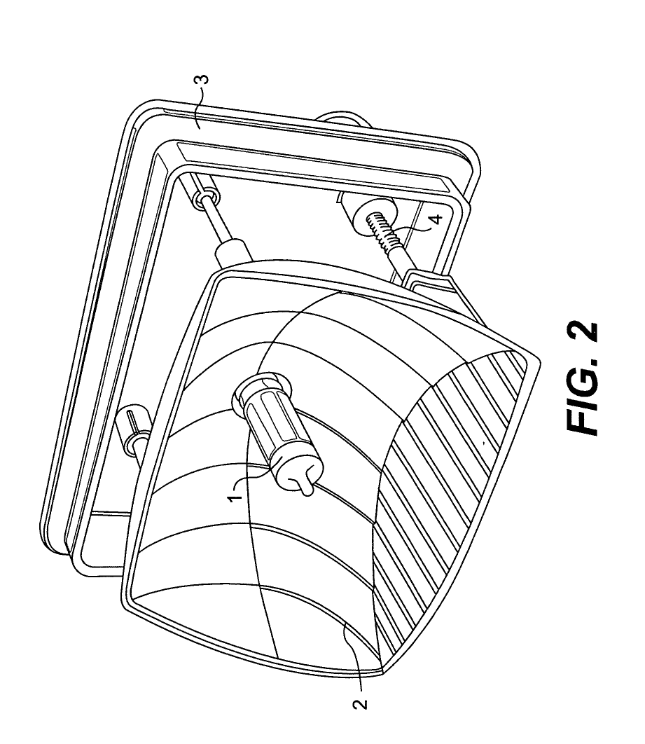

FIG. 2 is a perspective view of a headlight assembly similar to the headlight assembly 100 shown in FIG. 1 in accordance with another embodiment of the present invention. As shown in FIG. 2, the reflector 2 is mounted to the mounting plate 3 and the adjusting screw 4 may be adjusted to adjust the direction of the reflector 3 and thus redirect the light emitted from light bulb 1. Although the mounting plate 3 illustrated in FIG. 2 has a generally rectangular shape, it is contemplated that the mounting plate 3 may have a different shape, e.g., circular, elliptical, trapezoidal, triangular, irregular, polygonal, etc. Accordingly, it is contemplated that a suitable reflector 2 of the present invention may have a variety of shapes, e.g., circular, elliptical, rectangular, or polygonal, etc.

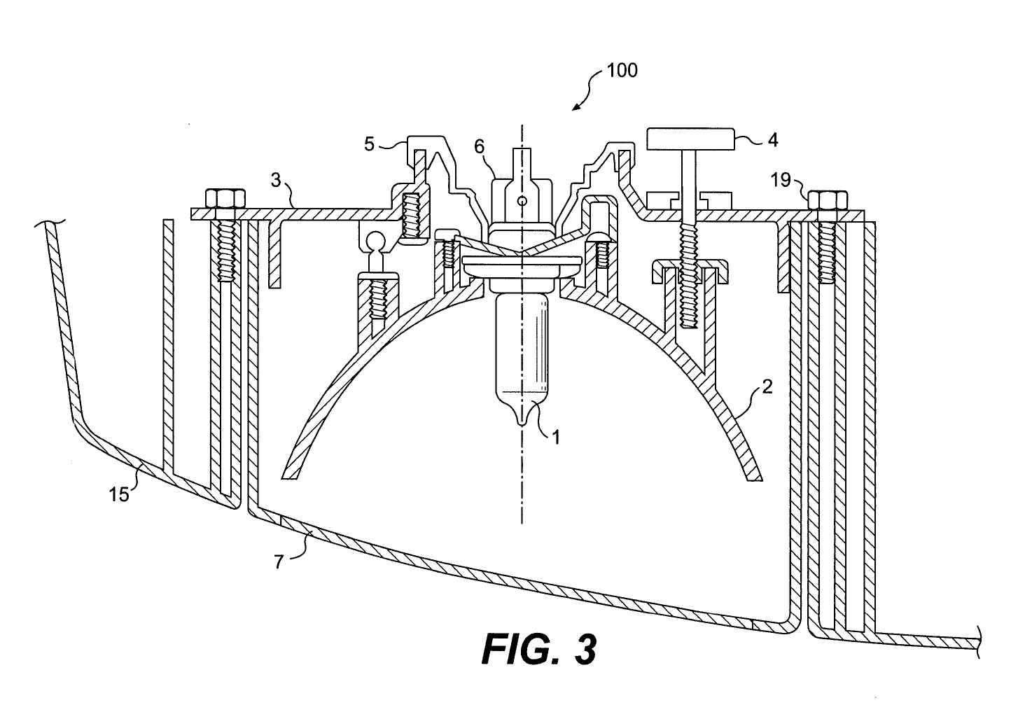

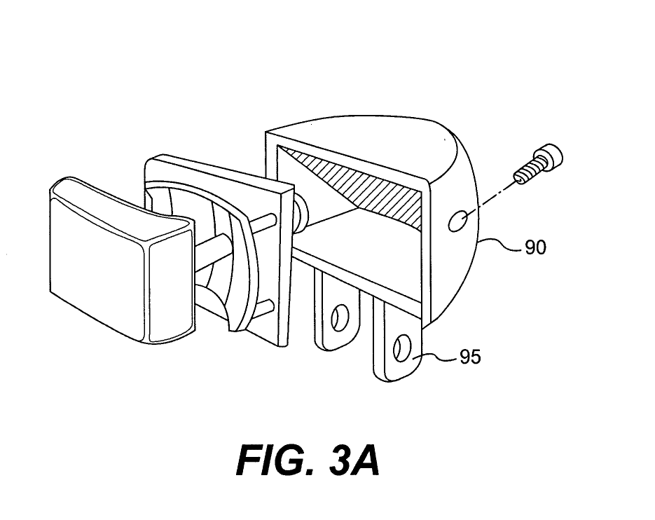

FIG. 3 is a detailed illustration of the headlight assembly 100 and lens assembly in accordance with another embodiment of the present invention. Lens 7 is provided in an orifice on a body 15 of a vehicle. The headlight assembly 100 described above is coupled to the body 15 of the vehicle via at least one fastener 19. The lens 7 is mounted between a portion of the mounting plate 3 that extends outwardly from the body 15 of the vehicle. As may be appreciated by one skilled in the art, the lens 7 may be held in place by the friction produced between the mounting plate 3 and the body 15. Additionally, an adhesive such as glue may be used to hold the lens securely in a groove between the mounting plate 3 and the body 15. It is also contemplated that the lens 7 may be sealed to the mounting plate 3 with, for example, a rubber seal or glue.

The lens 7 may have various patterns, textures, colors, or optical features to improve performance and aesthetics. For example, portions of the lens 7 may be used to hide mechanical features of the headlight assembly 100. Also, the lens 7 may be specifically designed for the type of vehicle on which it is to be installed, thereby matching the overall design of the vehicle. For example, the lens 7 for an ATV may be different that a lens for a boat or a snowmobile.

Although FIGS. 1-3 show embodiments of the headlight assembly 100 configured to be mounted to the body of the vehicle, FIG. 3A shows another headlight assembly that may be mounted to a different part of the vehicle, e.g., the steering column, on top of the body, or under the body. FIG. 3A illustrates an end cap 90 with a connecting portion 95 that may be used for this purpose.

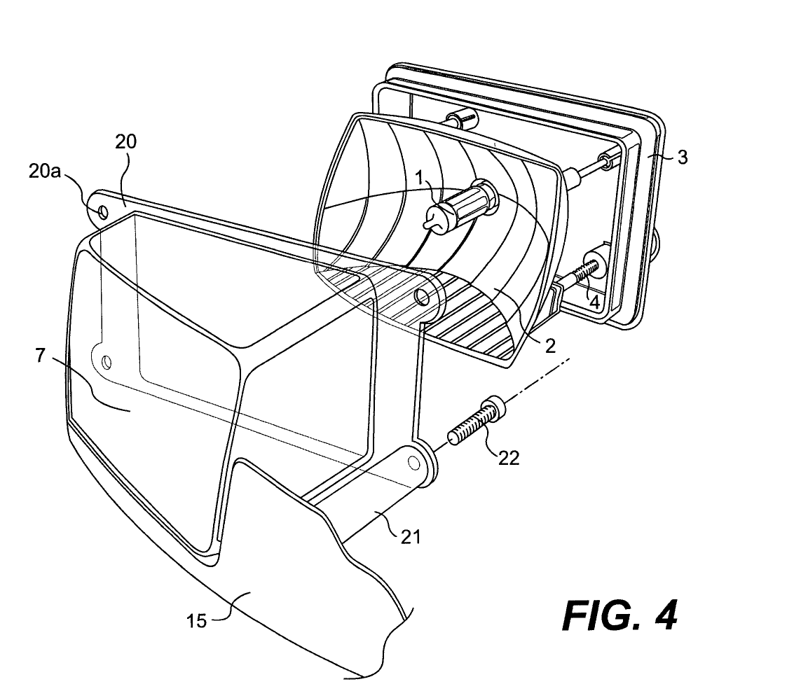

FIG. 4 is a perspective view of the headlight assembly 100 and lens assembly as shown in FIG. 3 in accordance with this embodiment of the present invention. In this embodiment, the lens 7 is provided in an orifice on the body 15 of a vehicle. The headlight assembly 100, as described above, may be coupled to the lens 7 and/or the body 15. It is understood that the headlight assembly 100 may be mounted in a plurality of different configurations.

In this embodiment, the lens 7 is provided with a flange 20. The flange 20 includes a plurality of holes 20a that may be coupled to a portion of the body 15, e.g., a post 21, via a fastener 22. The mounting plate 3 may be bonded to the lens 7 by conventional methods. Alternatively, the mounting plate 3 may include holes that align with the holes 20a and the fastener 22 may be used to couple both the mounting plate 3 and the lens 7 to the post 21. IAs would be appreciated by those skilled in the art, there are many acceptable methods of mounting the headlight assembly 100 to the body 15 of the vehicle.

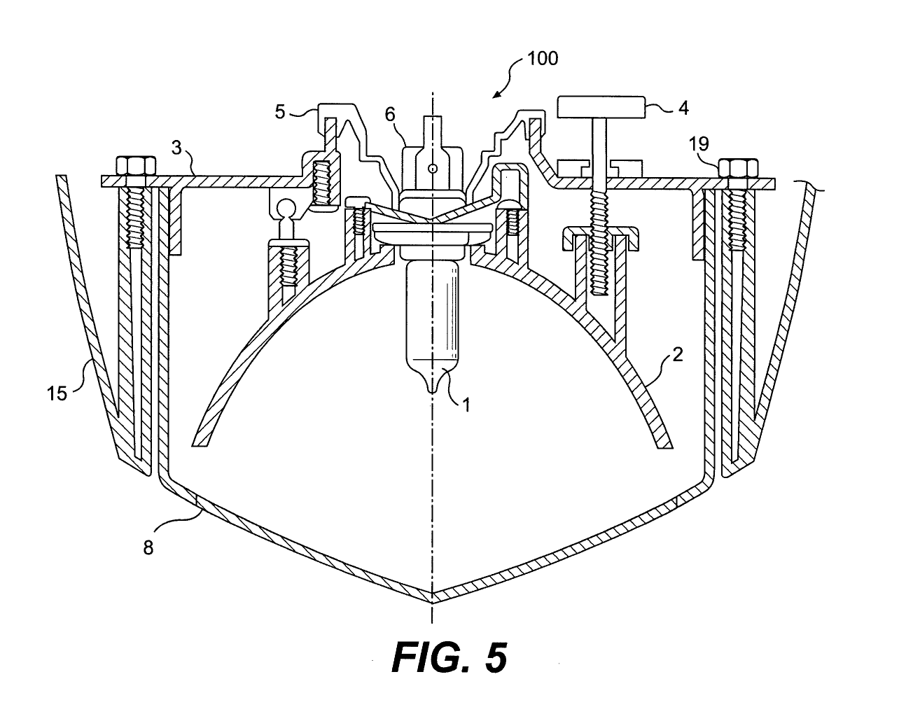

FIG. 5 is a detailed illustration of the headlight assembly 100 and lens assembly in accordance with still another embodiment of the present invention. A lens 8 is provided in an orifice on the body 15 of a vehicle, and the headlight assembly 100, described above, is coupled to the body 15 of the vehicle via at least one fastener 19. In this manner, it is possible to vary the body designs and lens configurations, as suggested by the differences between the lens 7 (FIGS. 3 and 4) and the lens 8 without redesigning the headlight assembly 100. The lens 8 in FIG. 5 may be best suited for a vehicle with a single headlight located in a center portion of the front of the vehicle, e.g., a snowmobile. It is also contemplated that the lens 8 may be used for a dual headlight assembly having one headlight over the other.

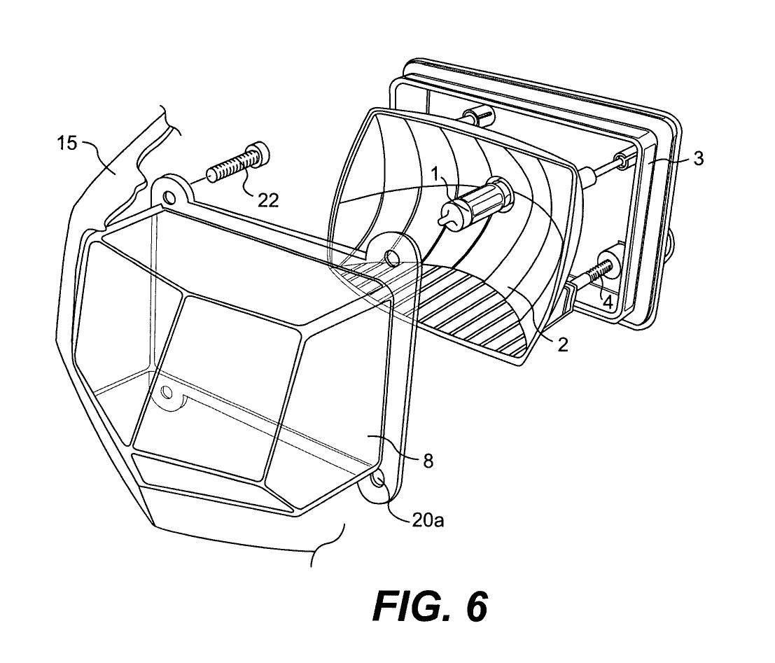

FIG. 6 is a perspective view of the headlight assembly 100 and lens assembly 8 as shown in FIG. 5. The lens 8 is mounted to the body 15 and the headlight assembly 100, as described above, may be mounted to the body 15 of the vehicle and/or the lens 8. As described above in connection with FIG. 4, the lens 8 is provided with holes 20a and may be attached to the body 15 via a fastener 22 or any other acceptable fastening device such as a snap type fastener or an adhesive.

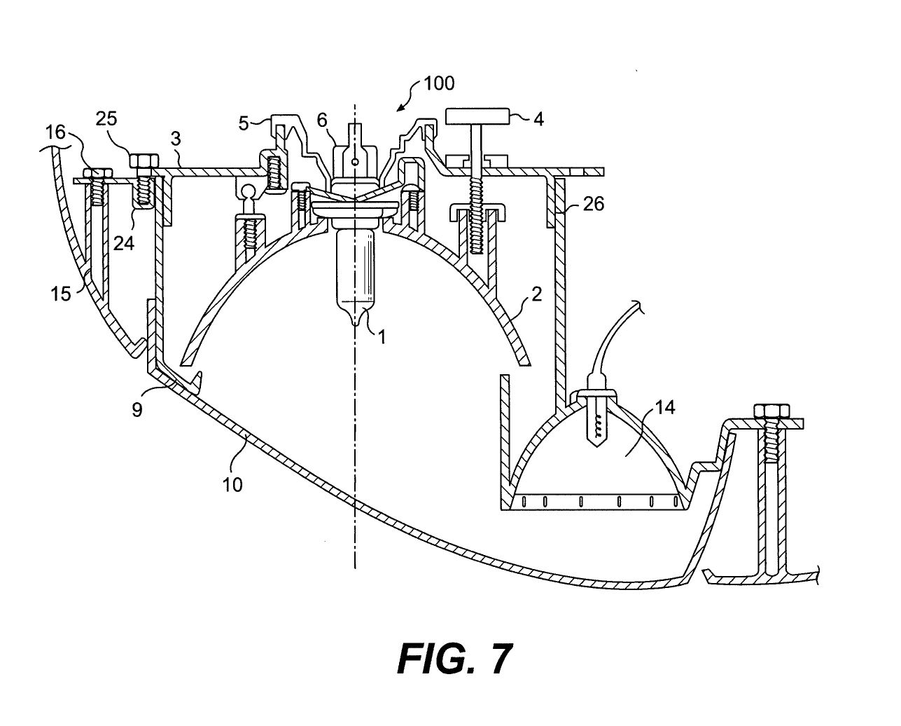

FIG. 7 is a detailed illustration of the headlight assembly 100 and lens assembly in accordance with an additional embodiment of the present invention. In this embodiment, a lens 10 is mounted to a connecting portion 9, rather than being directly mounted to the mounting plate 3, as shown in FIGS. 3 and 5. The connecting portion 9 is coupled to the mounting plate 3. As illustrated in FIG. 7, the connecting portion 9 has an accepting portion 24 which is configured to accept a fastener 25 to couple the connecting portion 9 to the mounting plate 3. Also, as shown in FIG. 7, the connecting portion 9 may be coupled to the mounting plate 3 via an adhesive as shown by joint 26.

In this embodiment, an additional light source 14 is provided. The additional light source 14 may serve a variety of purposes, including but not limited to a high beam light or a turn signal indicator. Also, the additional light source 14 may be used to implement various lighting techniques, including but not limited to LED's or High Intensity Discharge (HID) lighting. The additional light source 14 may also be integrated into the connecting portion 9.

Therefore, it is possible to further modify the vehicle body 15 and the lens 10 to include the additional light source 14 without modifying the headlight assembly 100 as described above with respect to FIG. 1. Accordingly, the manufacturing and design costs may be reduced because the headlight assembly 100 may be used, unmodified, with the additional light source 14.

As previously discussed, the lens 10 may be sealed with the connecting portion 9 to prevent water and debris from entering the headlight assembly. Further, the connecting portion 9 may be made of various materials that include various patterns, textures, colors or optical features to improve performance and aesthetics. The configuration with lens 10, illustrated in FIG. 7, may be well suited for a recreation vehicle with a headlight on either side of the front of the vehicle.

Various methods may be used to couple the lens 10 to the body 15 of the vehicle. For example, the lens 10 may be fastened or snap-fit to the connecting portion 9 and the connecting portion may be coupled to the body 15 of the vehicle by a fastener 16. Alternatively, the lens 10 may be attached directly to the body 15 with an adhesive or a fastener.

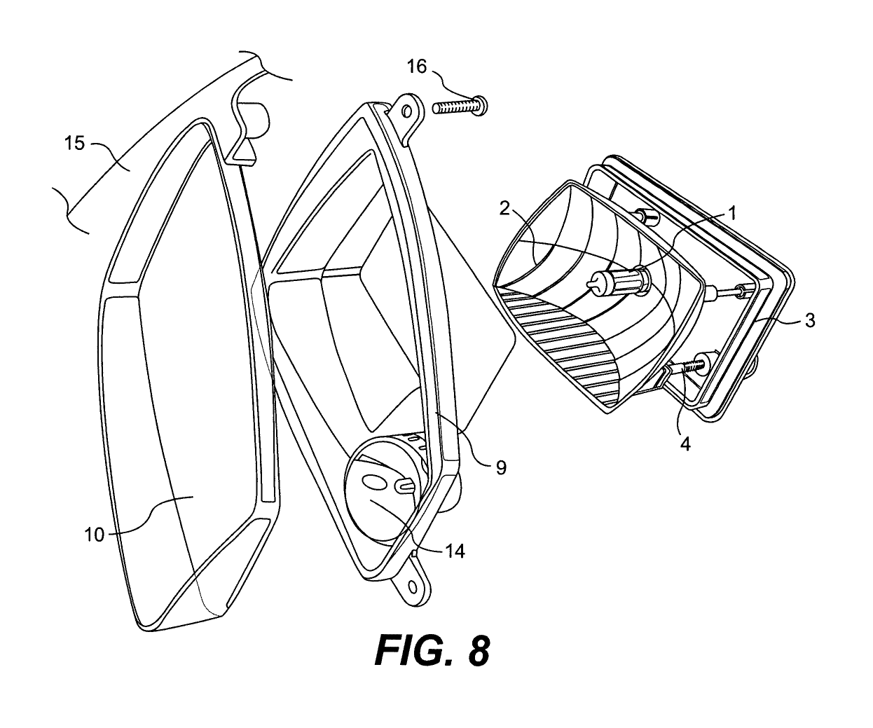

FIG. 8 is a perspective view of the headlight assembly 100 and lens assembly as shown in FIG. 7. The lens 10 is mounted to the connecting portion 9 via an adhesive or friction coupling method. The connecting portion 9 may be coupled to the mounting plate 3. In addition, the connecting portion 9 may be coupled to the body 15 via a fastener 16 or any other suitable coupling method. As mentioned previously, a variety of suitable connecting methods may be used, for example, as shown in FIG. 7, a fastener 25 is used to couple the mounting plate 3 to the connecting portion 9. Accordingly, it is possible to couple the mounting plate 3 to the connecting portion 9 via an adhesive or by a fitted friction connection of the two pieces. As shown in FIG. 8, the additional light source 14, which is integrated into the connecting portion 9, may be integrated by several methods, including but not limited to inserting the additional light source 14 into the connecting portion 9 and coupling the additional light source 14 to the connecting portion 9, or forming the additional light source 14 with the connecting portion 9.

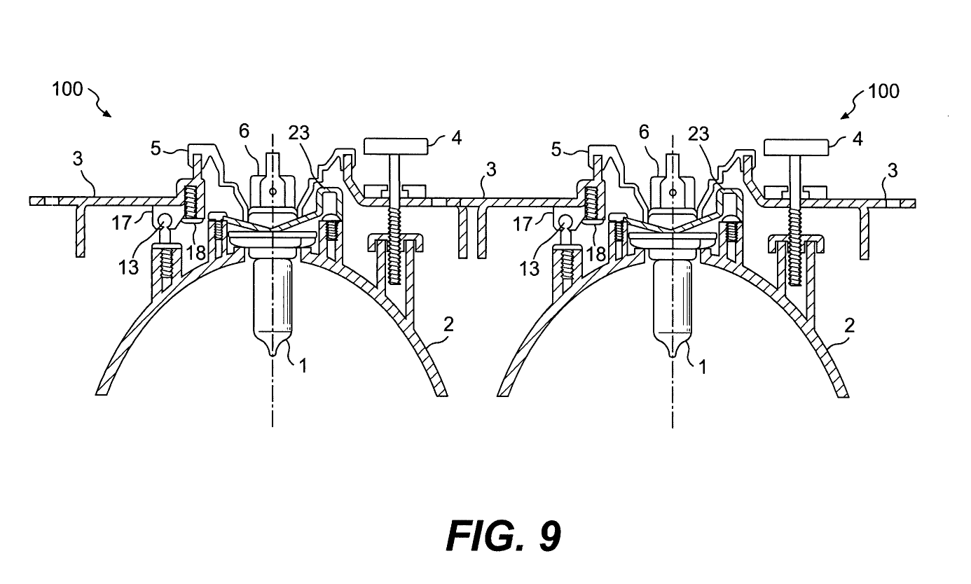

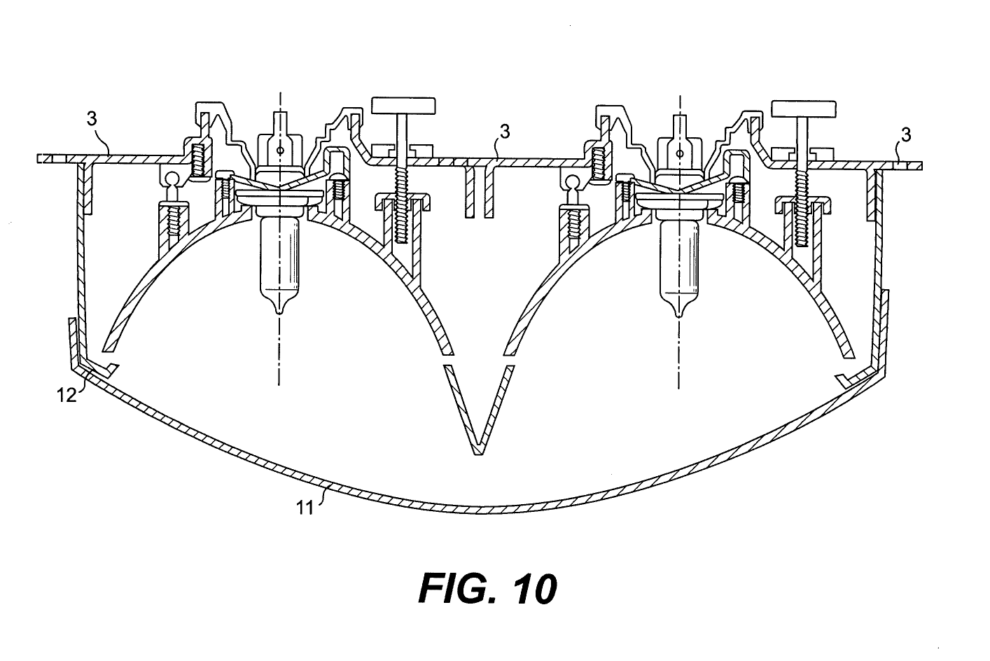

FIGS. 9 and 10 are detailed illustrations of two headlight assemblies 100 and a lens assembly in accordance with a further embodiment of the present invention. In this embodiment, two headlight assemblies 100, as described with respect to FIG. 1, may attach to a single mounting plate, or the mounting plates 3 of each headlight assembly may be coupled together. In this embodiment, each headlight assembly 100 is identical to that shown in FIG. 1 and each headlight assembly 100 may be adjusted via its own adjusting screw 4. However, the adjustment may be arranged such that both reflectors may be adjusted by a single adjusting screw 4.

As shown in FIG. 10, a lens 11 is provided on a connecting member 12. The connecting member 12 may be attached to the mounting plate 3 via an adhesive bond or with a fastener. The headlight assembly 100, as described above in connection with FIG. 1, may be used without modification. The lens 11 may be modified to accommodate mounting on either side of the vehicle as described with respect to FIG. 3. It is contemplated that the additional headlight assembly 100 may be used as a normal light or in a high beam configuration.

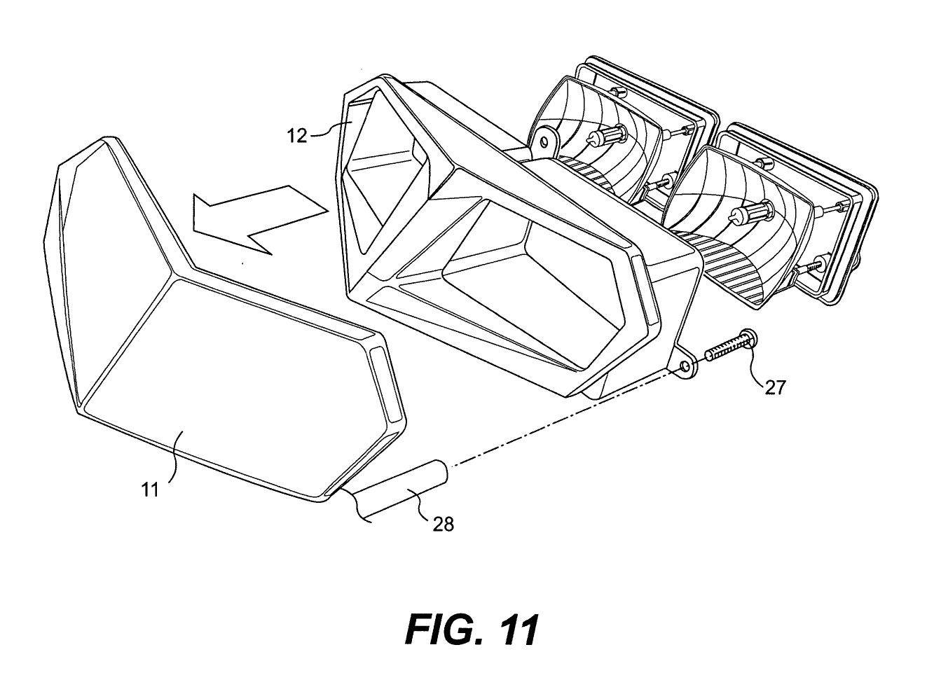

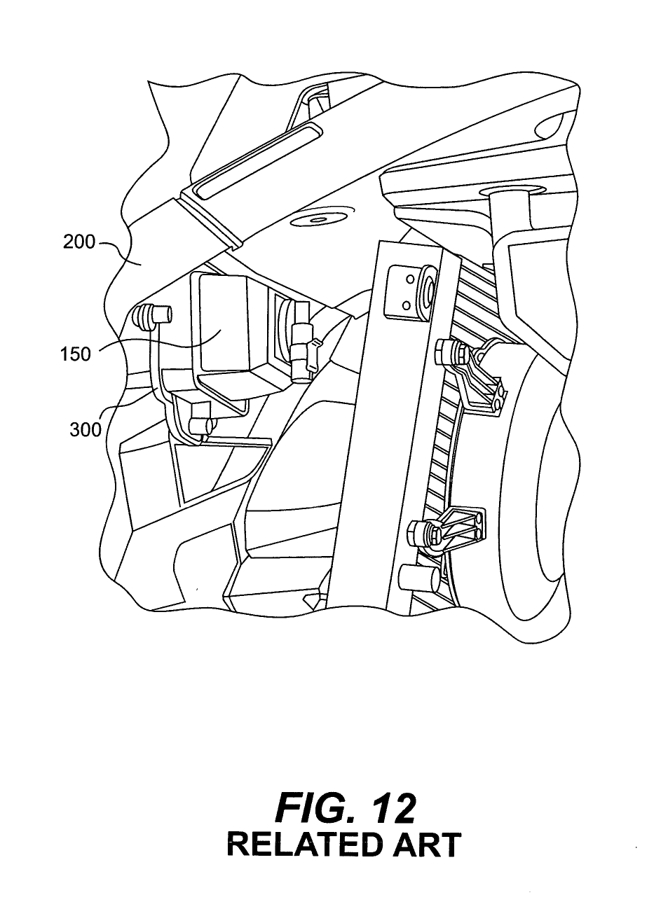

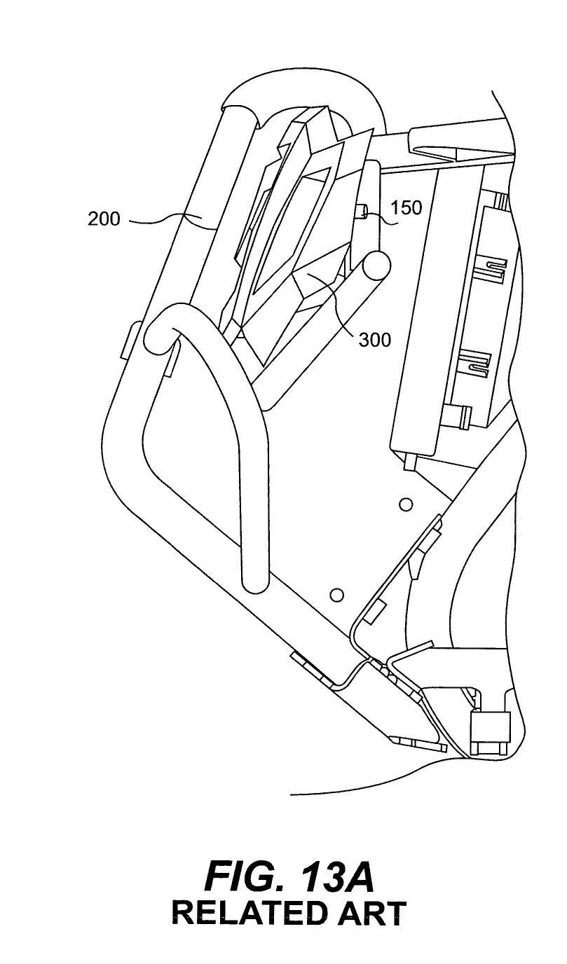

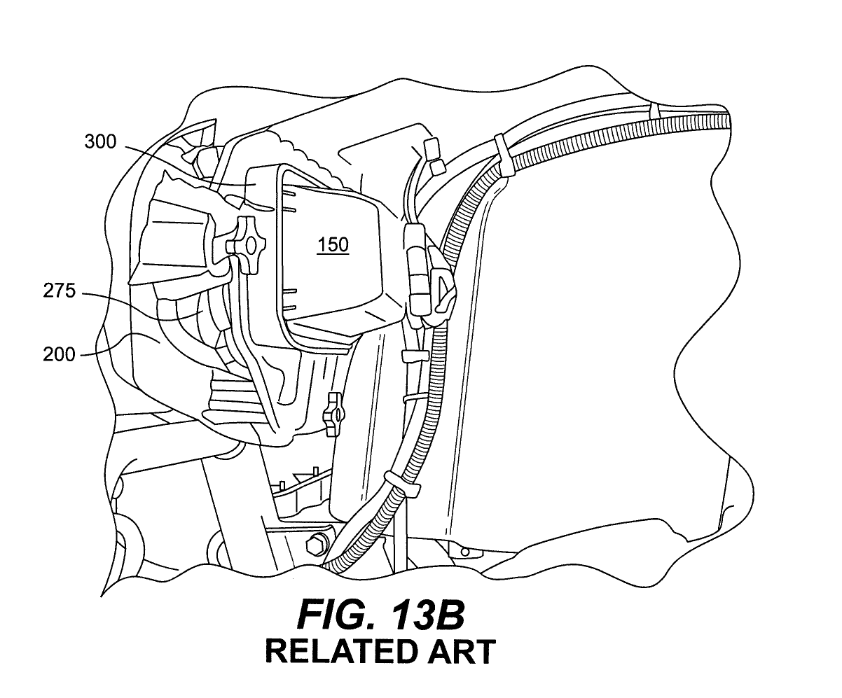

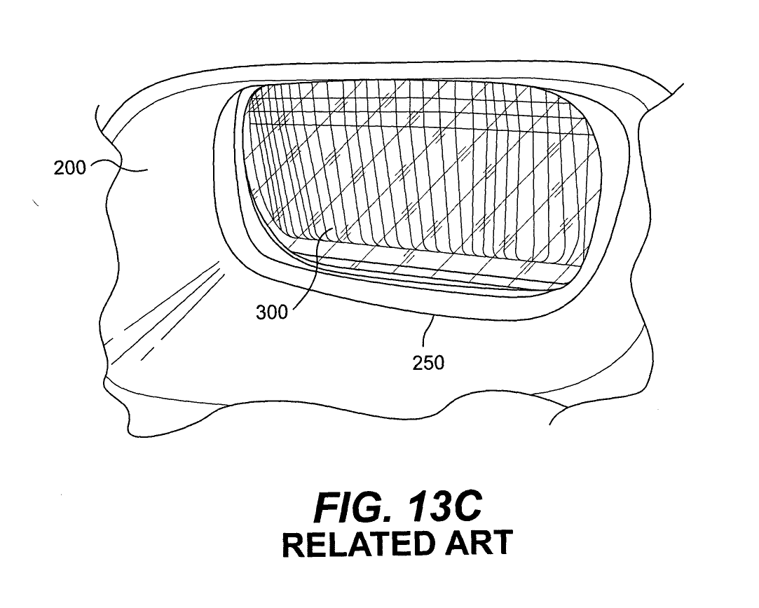

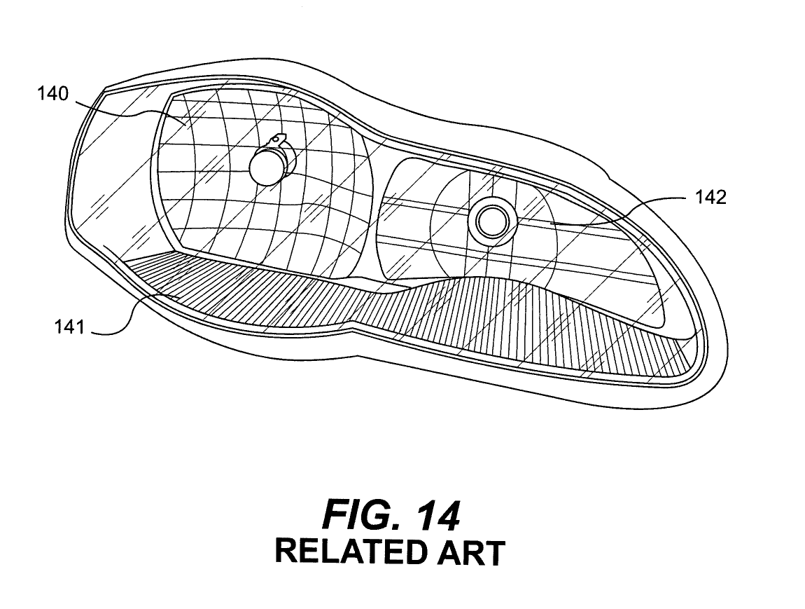

FIG. 11 is a perspective view of the headlight assembly 100, as illustrated in FIG. 9, and the lens 11, as illustrated in FIG. 10. Similar to FIG. 8, the connecting portion 12 is coupled to the lens 11 via an acceptable coupling method, such as an adhesive bond. As described above with regard to FIGS. 1-10, a variety of coupling methods may be used to couple the various pieces of the headlight assembly to the body and to the lens. For example, as shown in FIG. 11, a fastener 27 may be used to couple the connecting portion 12 to the body portion 28.

Additionally, a method for manufacturing and/or constructing a recreational vehicle, e.g., an ATV, a snowmobile, etc., is provided by the present invention. The method includes forming at least one headlight assembly, forming a body portion of the recreational vehicle, and providing a lens. The headlight assembly includes a reflector and a mounting portion that is configured to accept a light source. The lens is configured to be inserted into an orifice on a front portion of the body portion of the recreational vehicle. The method further includes coupling the mounting portion to at least one of the lens and the body portion of the recreational vehicle. The headlight assembly can be mounted to a plurality of different recreational vehicles having different orifice configurations without modification to the headlight assembly.

The method may also include coupling a connecting member between the headlight assembly and the lens. The headlight assembly may be configured to be mounted to a plurality of connecting members without modification to the headlight assembly.

The foregoing presentation of the described embodiments is provided to enable any person skilled in the art to utilize the present invention. Various modifications to these embodiments are possible and the generic principle of a modular headlight structure for recreational vehicles presented herein may be applied to other embodiments as well. Thus, the present invention is not intended to be limited to the embodiments shown and described above, but rather to be accorded the widest scope consistent with the principles and novelty of the features disclosed in any fashion herein.

1. A headlight sub-assembly comprising:
a mounting plate;
a reflector coupled to said mounting plate via at least one joint; and
at least one adjusting screw for adjusting said reflector about said at least one joint relative to said mounting plate;
wherein said headlight assembly is configured to be coupled to at least one lens from a group of selected lenses having different configurations.

2. A headlight assembly for a vehicle, said headlight assembly comprising:
a headlight subassembly, wherein said subassembly comprises a mounting plate, at least one reflector coupled to said mounting plate via at least one joint, and at least one adjusting screw to adjust said reflector about said at least one joint relative to said mounting plate; and
a lens associated with the sub-assembly;
wherein at least one of a shape and a configuration of said reflector is independent of a shape and configuration of said lens.

3. The headlight assembly as claimed in claim 2, wherein said mounting plate comprises two reflectors covered by the lens.

4. The headlight assembly as claimed in claim 2, further comprising a connecting member coupled between said mounting plate and said lens.

5. The headlight assembly as claimed in claim 4, wherein said connecting member has an auxiliary light source.

6. A recreational vehicle, said recreational vehicle comprising:
a body portion;
at least one headlight assembly comprising at least a reflector and a mounting portion; and
a lens coupled to said headlight assembly and secured to said body portion;
wherein a configuration of said headlight assembly is independent of at least one of a shape of said body portion and a shape of said lens.

7. The recreational vehicle as claimed in claim 6, wherein said recreational vehicle is an all terrain vehicle and said body portion comprises two laterally spaced orifices, one on each side of a front portion of said body portion.

8. The recreational vehicle as claimed in claim 6, wherein said recreational vehicle is a snowmobile and said body portion comprises a single orifice, in a center portion of a front portion of said body portion.

9. The recreational vehicle as claimed in claim 6, wherein said configuration of said headlight assembly is independent of both the shape of said body portion and the shape of said lens.

10. The recreational vehicle as claimed in claim 6, wherein said headlight assembly comprises two reflectors within said lens.

11. The recreational vehicle as claimed in claim 6, further comprising a connecting member coupled between said mounting plate and said lens.

12. The recreational vehicle as claimed in claim 11, wherein said connecting member has an auxiliary light source.

13. The recreational vehicle as claimed in claim 11, wherein said configuration of said headlight assembly is independent of a shape of said lens or connecting member.

14. A method for constructing a recreational vehicle, said method comprising:
forming at least one headlight assembly comprising a reflector and a mounting portion, configured to accept a light source;
forming a body portion of said recreational vehicle;
providing a lens configured to be inserted into an orifice on a front portion of said body portion of said recreational vehicle; and
coupling said mounting portion to at least one of said lens and said body portion of said recreational vehicle;
wherein said headlight assembly can be mounted to a plurality of different recreational vehicles having different orifice configurations without modification to said headlight assembly.

15. The method as claimed in claim 14, further comprising coupling a connecting member between said headlight assembly and said lens.

16. The method as claimed in claim 15, further comprising configuring said headlight assembly to be mounted to a plurality of different connecting members or lenses without modification to said headlight assembly.
